(19) United States
(12) Patent Application Publication
(10) Pub. No.: US 2025/0198312 A1
(43) Pub. Date: Jun. 19, 2025

(54) SOUND ATTENUATED ANGLED LOUVER WITH DRIP TRAY FOR TURBINE POWER GENERATOR ENCLOSURES

(71) Applicant: STEWART & STEVENSON LLC, Houston, TX (US)

(72) Inventors: Jason ROBISON, Houston, TX (US); Austin T. BREAUX, Houston, TX (US)

(21) Appl. No.: 18/938,379

(22) Filed: Nov. 6, 2024

Related U.S. Application Data
(60) Provisional application No. 63/612,185, filed on Dec. 19, 2023.

(51) Int. Cl. F01D 25/30; F01D 15/10; F01D 25/32

(52) U.S. Cl. CPC F01D 25/30; F01D 15/10; F01D 25/32

(57) ABSTRACT

An enclosed generator system includes a turbine, an alternator mechanically connected to the turbine and an enclosure, the turbine and the alternator mounted to a base frame of the enclosure, the enclosure including a louvered exit. The enclosed generator system also includes a louvered assembly. The louvered assembly includes a frame, the frame having a horizontal bottom and vertical sides and a plurality of louvers positioned within the frame, the louvers at an upward angle to the horizontal bottom and having a bottom edge. The louvered assembly also includes a first drip tray, the first drip tray affixed to the horizontal bottom.

### CROSS-REFERENCE TO RELATED APPLICATIONS

This application is a nonprovisional application which claims priority from U.S. provisional application No. 63/612,185, filed Dec. 19, 2023, which is incorporated by reference herein in its entirety.

### TECHNICAL FIELD/FIELD OF THE DISCLOSURE

The present disclosure relates to turbine generator enclosures with angled louvers.

### BACKGROUND OF THE DISCLOSURE

Generators may be packaged in enclosures for protection from the environment. In some instances, the generator may use a turbine engine. Radiant heat from the turbine may heat the air within the enclosure, which traditionally is exhausted outside of the enclosure, generating noise. Turbine powered generators themselves may generate sound of 100 dB or greater.

### SUMMARY

An enclosed generator system is disclosed. The enclosed generator system includes a turbine, an alternator mechanically connected to the turbine and an enclosure, the turbine and the alternator mounted to a base frame of the enclosure, the enclosure including a louvered exit. The enclosed generator system also includes a louvered assembly. The louvered assembly includes a frame, the frame having a horizontal bottom and vertical sides and a plurality of louvers positioned within the frame, the louvers at an upward angle to the horizontal bottom and having a bottom edge. The louvered assembly also includes a first drip tray, the first drip tray affixed to the horizontal bottom.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 depicts a cutaway side view of an enclosed generator system consistent with certain embodiments of the present disclosure.

FIG. 2 depicts a perspective view of an enclosure of the enclosed generator system consistent with certain embodiments of the present disclosure.

FIG. 3 depicts a perspective front view of a louvered assembly consistent with certain embodiments of the present disclosure.

FIG. 4 depicts a side view of a louvered assembly consistent with certain embodiments of the present disclosure.

FIG. 5 depicts a rear perspective view of a louvered assembly consistent with certain embodiments of the present disclosure.

FIG. 6 depicts a rear view of a louvered assembly consistent with certain embodiments of the present disclosure.

FIG. 7 depicts a rear view of a louvered assembly consistent with certain embodiments of the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

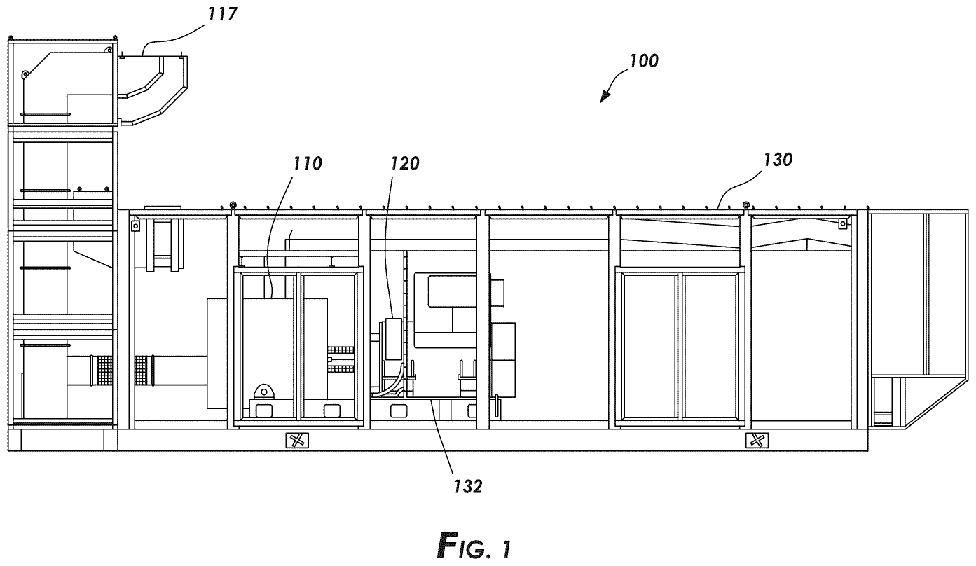

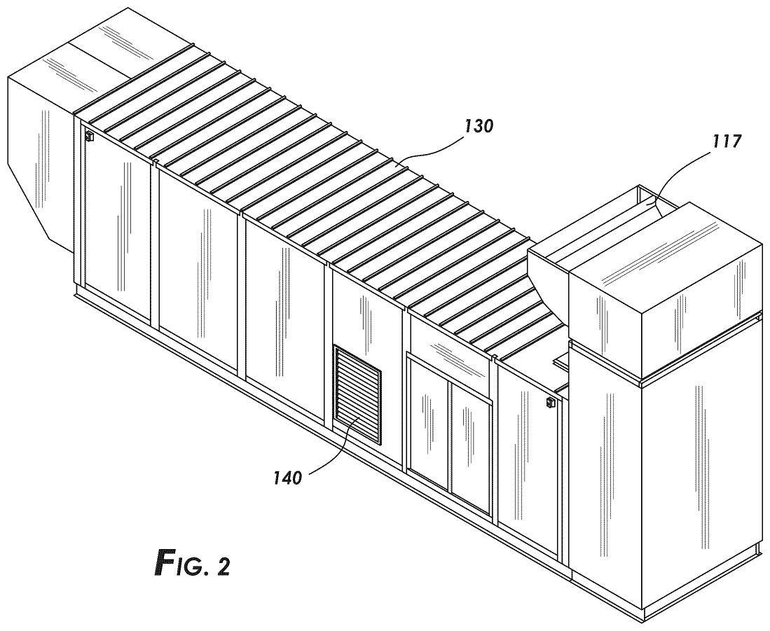

FIG. 1 is a cutaway side view of enclosed generator system 100 consistent with certain embodiments of the present disclosure. Enclosed generator system 100 includes turbine 110 mechanically connected to alternator 120. Both turbine 110 and alternator 120 are mounted to enclosure base frame 132 of enclosure 130. Turbine exhaust may exit enclosure 130 through turbine exhaust exit 117. Turbine 110 may be the source of significant noise. In certain embodiments, such as that shown in FIG. 2, heated air from inside enclosure 130 may exit enclosure 130 through louvered exit 140. As one of ordinary skill in the art with the benefit of this disclosure will understand, louvered assembly 150, described hereinbelow, may be affixed to enclosure 130 where desired.

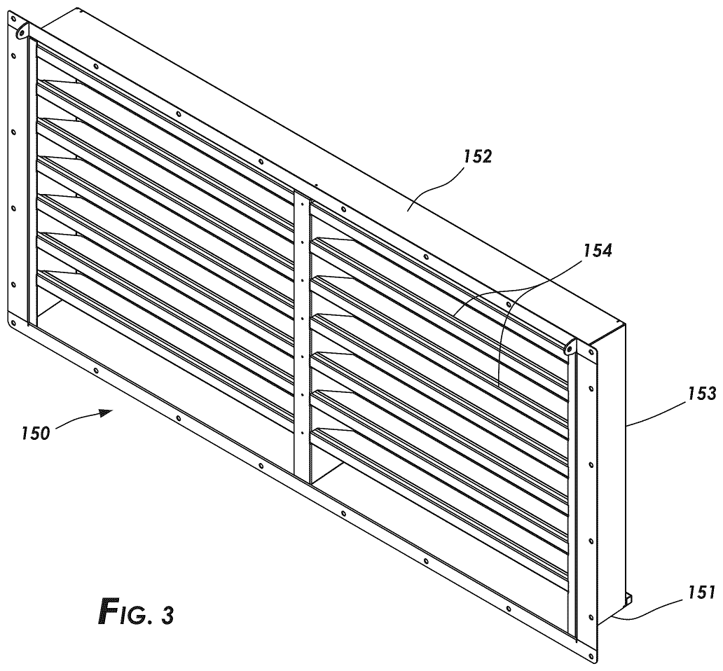

Louver assembly 150, as shown in FIG. 3, is positioned within louvered exit 140. Louver assembly 150 includes frame 152 and louvers 154. Frame 152 may include horizontal bottom 151 and vertical sides 153. Horizontal bottom 151 is nominally horizontal and may differ from horizontal by as much as 30°. Vertical sides 153 are nominally vertical and may differ from vertical by as much as 30°.

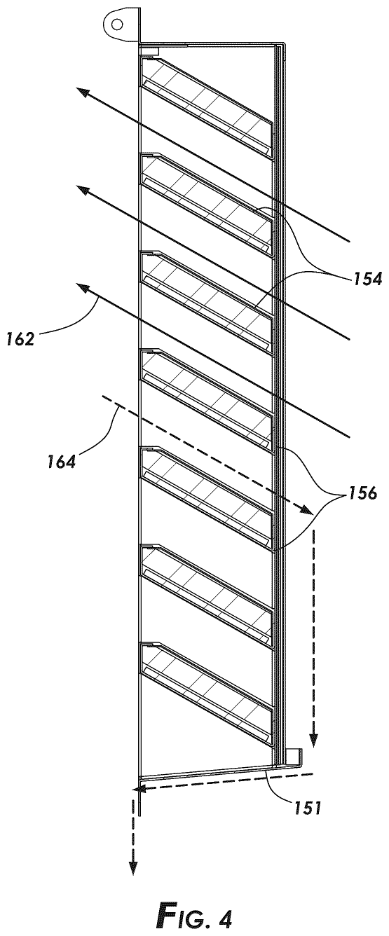

FIG. 4 is a side view of louvers 154. Louvers 154 may be angled with respect to horizontal bottom 151. For example, louvers 154 may be angled with respect to horizontal bottom 151 between 0° and 90°, or between 30° and 60°, or approximately 45° (upwardly). Angling louvers 154 upwardly with respect to horizontal bottom 151 may result in heated air from within enclosure 130 to be directed upwardly, away from passersby and nearby equipment. However, angling louvers 154 upwardly may also allow water such as rainwater into the enclosure. FIG. 4 depicts upward air path 162 and rainwater path 164.

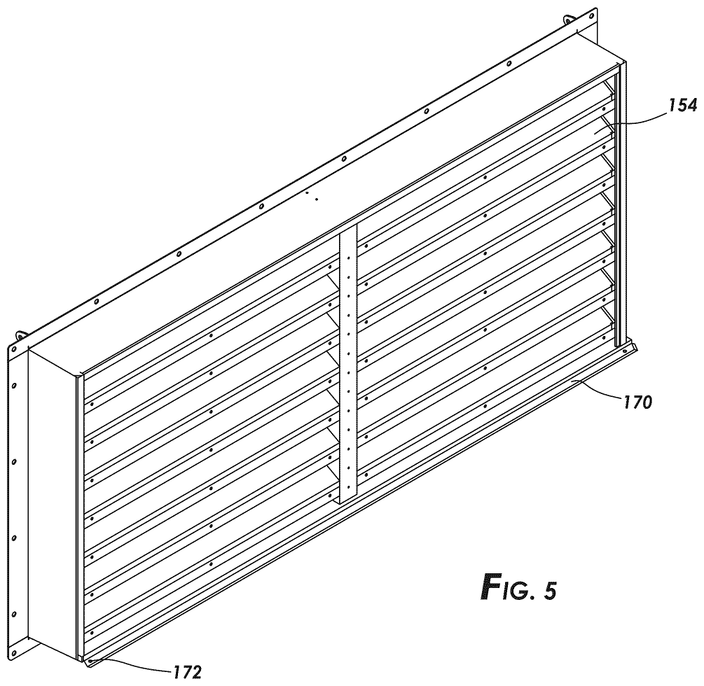

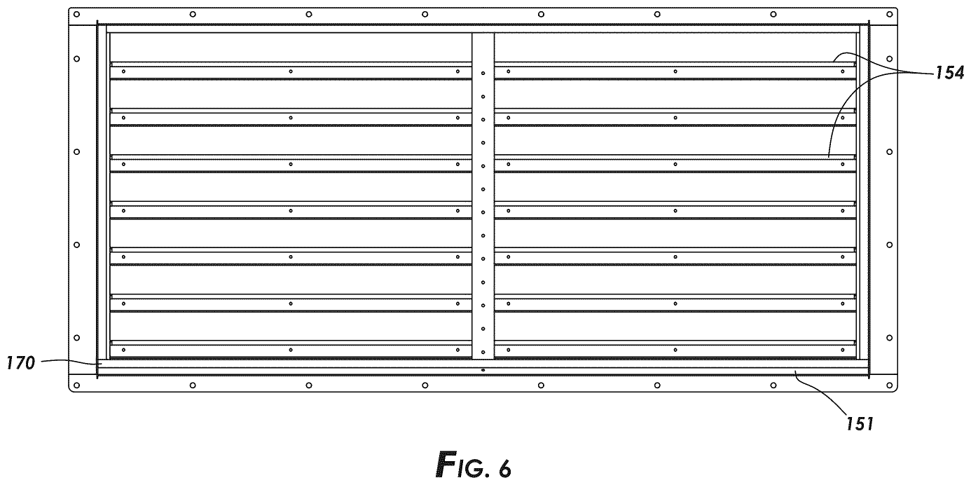

It is normally undesirable to have water enter enclosure 130. As a result, drip tray 170 may be included in louver assembly 150, as shown in FIGS. 5 and 6. In certain embodiments, drip tray 170 may be affixed to horizontal bottom 151. Drip tray 170 may include drain hole 172 adapted to drain any liquids collected along horizontal bottom 151 so as to avoid or restrict liquid from entering enclosure 130.

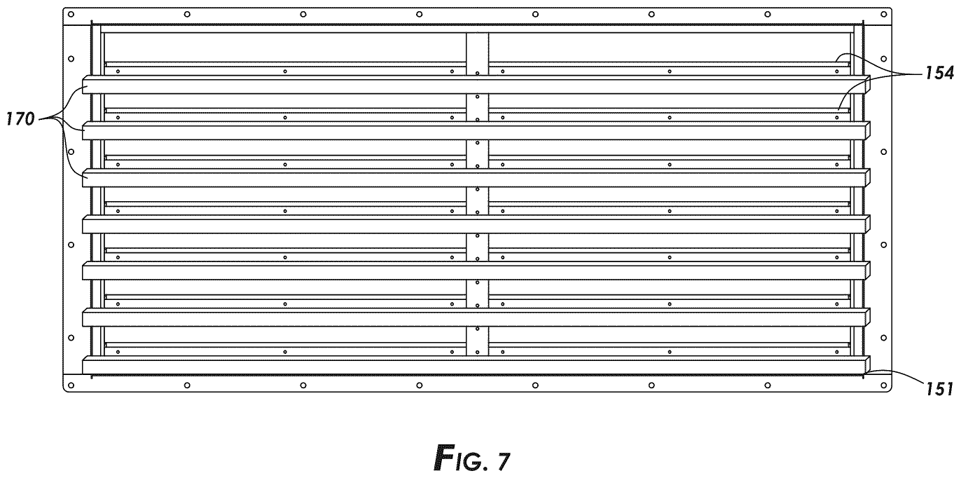

In certain embodiments, as shown in FIG. 7, louver assembly 150 may include a plurality of drip trays 170 arranged along bottom edges 156 of louvers 154 (shown in FIG. 4).

Louver assembly 150 may reduce the sound of turbine 110 outside of enclosure 130.

The foregoing outlines features of several embodiments so that a person of ordinary skill in the art may better understand the aspects of the present disclosure. Such features may be replaced by any one of numerous equivalent alternatives, only some of which are disclosed herein. One of ordinary skill in the art should appreciate that they may readily use the present disclosure as a basis for designing or modifying other processes and structures for carrying out the same purposes and/or achieving the same advantages of the embodiments introduced herein. One of ordinary skill in the art should also realize that such equivalent constructions do not depart from the spirit and scope of the present disclosure and that they may make various changes. substitutions, and alterations herein without departing from the spirit and scope of the present disclosure.

1. An enclosed generator system comprising:
a turbine;
an alternator mechanically connected to the turbine;
an enclosure, the turbine and the alternator mounted to a base frame of the enclosure, the enclosure including a louvered exit; and
a louvered assembly, the louvered assembly positioned within the louvered exit and including:
a frame, the frame having a horizontal bottom and vertical sides;
a plurality of louvers positioned within the frame, the louvers at an upward angle to the horizontal bottom and having a bottom edge; and
a first drip tray, the first drip tray affixed to the horizontal bottom.

2. The enclosed generator system of claim 1, wherein the drip tray includes a drain hole adapted to drain liquids along the horizontal bottom.

3. The enclosed generator system of claim 1 having a second drip tray, the second drip tray affixed to the lower edge of one of the plurality of louvers.

4. The enclosed generator system of claim 1, wherein each of the plurality of louvers is angled between 0° and 90° relative to the horizontal bottom.

5. The enclosed generator system of claim 4, wherein the each of the plurality of louvers is angled between 30° and 60° relative to the horizontal bottom.

6. The enclosed generator system of claim 4, wherein the each of the plurality of louvers is angled at about 45° relative to the horizontal bottom.
